(19) United States
(12) Patent Application Publication
(10) Pub. No.: US 2026/0177072 A1
(43) Pub. Date: Jun. 25, 2026

(54) PITCH-CHANGE MECHANISM WITH CANTILEVERED PITCH-LOCKING DEVICE

(71) Applicant: Safran Aircraft Engines, PARIS (FR)

(72) Inventors: Christophe Marcel Lucien PERDRIGEON, MOISSY-CRAMAYEL (FR); Clément COTTET, MOISSY-CRAMAYEL (FR); Régis Eugène Henri SERVANT, MOISSY-CRAMAYEL (FR); Jean Charles Olivier RODA, MOISSY-CRAMAYEL (FR)

(73) Assignee: Safran Aircraft Engines, PARIS (FR)

(21) Appl. No.: 19/124,715

(22) PCT Filed: Oct. 27, 2023
(86) PCT No.: PCT/FR2023/051700

§ 371 Date: Apr. 25, 2025

(30) Foreign Application Priority Data
Oct. 28, 2022 (FR) FR2211292

(51) Int. Cl. F04D 29/36; F04D 29/32

(52) U.S. Cl. CPC F04D 29/362; F04D 29/329

(57) ABSTRACT

The invention relates to a pitch-change mechanism (70), which comprises a frame (72), a control actuator (74) including a stationary portion (100) rigidly connected to the frame (72) and a movable portion (102) translatable along a longitudinal axis (X), a connection system (78) connecting the movable portion (102) to a variable-pitch blade (56) so as to convert the translation of the movable portion (102) into a rotation of the variable-pitch blade (56), and a pitch-locking device (160) capable of blocking the translation of the movable portion (102) relative to the stationary portion (100) in at least one direction. The pitch-locking device (160) is cantilevered longitudinally relative to the frame (72).

### FIELD OF THE INVENTION

The present invention concerns the general field of turbomachines equipped with at least one fan provided with variable-setting blades, and more particularly the control of the orientation of the fan airfoils of these turbomachines.

One preferred field of application of the invention is that of turbojet engines with unducted fan (better known as propfan, open fan, open rotor and unducted fan). However, the invention also applies to turboprop engines with one or more pusher propellers.

### TECHNOLOGICAL BACKGROUND

One of the avenues currently being explored to improve the specific consumption of civil airplane engines is the development of unducted fan turbojet engines, such as the one described in document FR 2 941 493. These turbojet engines include a conventional turbine engine gas generator, one or more turbine stages of which drive one or more unducted fans extending outside the nacelle of the engine.

The blades of this/these fan(s) are, as in the case of conventional turboprop engines, variable-setting blades, that is to say the angular position of these blades (called the setting angle) can be modified during flight. As a reminder, the setting angle of a blade corresponds to the angle, in a plane orthogonal to the pivot axis of the blade, between the axis of rotation of the fan and the chord of the blade at 75% of the radius of the fan. It can vary from a value equal to 90° corresponding to a position called “web” or “flat” position of the blade, to a value equal to 0° corresponding to a position called “feather” position of the blade. It can also take a value strictly greater than 90°, typically substantially equal to 95°, corresponding to a position called “reverse” position of the blade.

As is well known, this modification of the setting angle during flight allows for the development of the engine thrust and for the optimization of the fan efficiency depending on the speed of the aircraft. Indeed, the rpm of the fans is almost constant throughout all phases of operation, and it is the setting of the blades that varies the thrust. Thus, during cruise flight phase, the blades are oriented so as to adjust the thrust by minimizing the power taken from the turbine shaft and the consumption and by optimizing efficiency. Conversely, during takeoff, the blades are oriented so as to maximize the thrust in order to accelerate and then take off the airplane.

The steering of the orientation of the blades is commonly performed by means of a pitch change mechanism comprising a control actuator including a movable part in translation along the axis of the fan and a connection system connecting the movable part to the blade so as to convert the translation of the movable part into a rotation of the variable-setting blade.

One difficulty encountered with the variable-setting blades is that, in case of malfunction in the systems steering their orientation, said blades tend, under their own centrifugal effect, to move into the flat position. However, a blade blocked in this position generates little resistive torque and risks causing the engine to overspeed, with potential risks of degradation of the engine. In addition, a blade blocked in this position also risks generating excessive drag that is unacceptable for the controllability of the airplane and/or its range in the case of a diversion mission.

To overcome this difficulty, it is known to use safety systems able to oppose the displacement of the variable-setting blades towards the small pitches (that is to say towards the flat position) in case of failure of the blade orientation control system. Such a system is for example known from EP 3 400 169.

In particular, a safety system integrating a ball screw-type screw-nut system coupled to a locking nut into the actuator controlling the orientation of the blades is known. In normal operation, the nut of the screw-nut system follows the displacements of the control actuator, thus causing the rotation of the screw about its axis, while the locking nut follows the screw thread without ever touching it (the tapping of the locking nut is designed to provide slight clearance with the screw thread). In case of malfunction of the blade orientation control system, the screw of the screw-nut system is immobilized (its rotation is blocked) and the locking nut engages with said screw, thus preventing the pivoting of the blades towards the small pitches.

This safety system is however not entirely satisfactory. Indeed, it makes access to the connection system connecting the blade to the movable part of the actuator difficult once the control system is installed. Furthermore, it is complex to assemble to the control actuator. In addition, it requires a control actuator with a specific geometry, making it heavy and bulky. Furthermore, for proper operation, it requires accurate and complex management of the clearances between the locking nut and the screw thread.

### DISCLOSURE OF THE INVENTION

One objective of the invention is to facilitate access to a pitch change mechanism steering the orientation of variable-setting blades when said pitch change mechanism comprises a pitch locking device and is assembled to a set of variable-setting blades. Other objectives are to allow lightening of the pitch change mechanism in order to allow simplification of the pitch change mechanism and to facilitate the assembly of the pitch change mechanism.

To this end, the invention relates, according to a first aspect, to a pitch change mechanism for adjusting an angular position of at least one variable-setting blade about a pivot axis of the blade, said pitch change mechanism comprising:
a frame fixed relative to the pivot axis,
a control actuator including a fixed part secured to the frame and a movable part movable in translation along a longitudinal axis relative to the fixed part between a retracted position and a deployed position,
a connection system connecting the movable part to the variable-setting blade so as to convert the translation of the movable part along the longitudinal axis into a rotation of the variable-setting blade about the pivot axis, and
a pitch locking device suitable for blocking the translation of the movable part relative to the fixed part in at least one way,
in which the pitch locking device is longitudinally cantilevered relative to the frame.

According to particular embodiments of the invention, the pitch change mechanism also has one or more of the following characteristics, taken separately or in any technically possible combination(s):
the pitch locking device comprises:
   a support member, movable in translation relative to the frame along the longitudinal axis between an operating position and a locking position,
   a guide system guiding the support member relative to the frame,
   a return device biasing the support member towards its locking position,
   a holding device for holding the support member in its operating position under normal operating conditions, and
   a screw-nut system with:
      a screw secured in translation to the support member and movably mounted in rotation about the longitudinal axis relative to the support member, the screw having an abutment surface which is at a distance from the frame when the support member is in the operating position and bearing against the frame when the support member is in the locking position, and
      a nut secured to the movable part of the actuator and coaxial with the screw, the nut cooperating with the screw so that a translation of the nut along the longitudinal axis causes the rotation of the screw about the longitudinal axis;
the control actuator and the guide system are disposed longitudinally on the same side, preferably a downstream side, of the nut;
the pitch change mechanism comprises a device for guiding the nut relative to the frame, said guide device including an inner cylinder secured to the nut and an outer cylinder secured to the frame, the inner cylinder cooperating with the outer cylinder so as to slide longitudinally inside the latter;
the pitch locking device comprises a casing secured to the nut and surrounding the nut, the screw and the support member;
the control actuator comprises a cylinder forming one of the fixed part and of the movable part and a piston forming the other of the fixed part and of the movable part, the cylinder delimiting an inner cavity and the piston dividing said inner cavity into two fluid chambers each containing a control fluid to control the displacement of the movable part relative to the fixed part;
one of the two fluid chambers is in fluid communication with the interior of the casing, the control fluid constituting a lubricating fluid for the locking device;
the fluid chambers are closed at each of the longitudinal ends of the actuator;
the casing at least partially delimits an enclosure for the circulation of a lubricating fluid for the pitch locking device;
the pitch change mechanism comprises a sealing fluidly isolating the fluid chambers from the pitch locking device;
the casing comprises an inner cylinder carrying the nut on an inner face and cooperating with an outer cylinder secured to the frame so as to slide longitudinally inside the latter, the inner cylinder having at its periphery a sealing in contact with an inner face of the outer cylinder, the outer cylinder and the casing together delimiting an enclosure for the circulation of a lubricating fluid for the locking device;
the connection system comprises a first articulation secured to the movable part, a second articulation secured to the variable-setting blade, away from the pivot axis, and a connection member connecting the first articulation to the second articulation;
the connection system is suitable for converting:
   a translation of the movable part along the longitudinal axis in a first way into a rotation of the variable-setting blade about the pivot axis towards the flat position, and
   a translation of the movable part along the longitudinal axis in a second way opposite to the first way into a rotation of the variable-setting blade about the pivot axis towards the feather position;
the first articulation is disposed upstream, respectively downstream, of the second articulation, the first way going from upstream to downstream, respectively from downstream to upstream;
the abutment surface is oriented in the first way;
the support member moves from its operating position to its locking position by translation in the first way;
the connection member is constituted by a connecting rod;
the variable-setting blade comprises a leading edge, a trailing edge and a chord connecting the leading edge to the trailing edge, the second articulation being placed opposite to the trailing edge relative to a plane orthogonal to the chord and containing the pivot axis;
the frame comprises a stopper against which the abutment surface of the screw is bearing when the support member is in the locking position, the control actuator and the stopper being disposed longitudinally on the same side of the nut;
the cylinder is continuous;
the fluid chambers are contiguous;
each fluid chamber is delimited at least partly by an outer peripheral surface of the frame;
the abutment surface is arranged at a downstream end of the screw, respectively at an upstream end;
the pitch locking device is out of said fluid chambers;
at least part of the pitch locking device extends longitudinally away from the actuator;
the pitch change mechanism comprises a shroud connecting the nut to the movable part of the actuator, said shroud protruding longitudinally, particularly upstream, from the actuator; and
the longitudinal axis is substantially orthogonal to the pivot axis.

The invention also relates, according to a second aspect, to a fan rotor for a turbomachine comprising a hub and a plurality of variable-setting blades each pivotable relative to the hub about an own pivot axis, the rotor further comprising a pitch change mechanism according to any one of the preceding claims to adjust an angular position of each of the variable-setting blades about its respective pivot axis.

According to one particular embodiment of the invention, the fan rotor also has the following characteristic:
the longitudinal axis constitutes an axis of rotation of the rotor.

The invention also relates, according to a third aspect, to a turbomachine comprising a fan rotor according to the second aspect.

According to one particular embodiment of the invention, the turbomachine also has the following characteristic:
the longitudinal axis constitutes an axis of elongation of the turbomachine.

The invention also relates, according to a fourth aspect, to an aircraft comprising at least one turbomachine according to the third aspect.

Finally, the invention relates, according to a fifth aspect, to a method for changing the pitch of the blades of a fan rotor for a turbomachine, each pivotable relative to a hub of the fan rotor about an own pivot axis, said method comprising the adjustment of an angular position of each of said blades about its respective pivot axis by means of a pitch change mechanism according to the first aspect.

According to one particular embodiment of the invention, the method also has the following characteristic:
the method comprises an additional step of locking the orientation of the blades by means of the pitch locking device.

### BRIEF DESCRIPTION OF THE FIGURES

Other characteristics and advantages of the invention will appear upon reading the following description, given solely by way of example and with reference to the appended drawings, in which:

FIG. 1 is a top view of an aircraft according to one exemplary embodiment of the invention,

FIG. 2 is a simplified view in partial longitudinal section of a turbomachine of the aircraft of FIG. 1,

FIG. 3 is a simplified view in longitudinal section of part of a pitch change mechanism of the turbomachine of FIG. 2 according to a first variant, the pitch change mechanism being in a first configuration,

FIG. 4 is a view similar to that of FIG. 3, the pitch change mechanism being in a second configuration,

FIG. 5 is a simplified view in longitudinal section of part of a pitch change mechanism of the turbomachine of FIG. 2 according to a second variant,

FIG. 6 is a simplified view in longitudinal section of part of a pitch change mechanism of the turbomachine of FIG. 2 according to a third variant,

FIG. 7 is a simplified view in longitudinal section of part of a pitch change mechanism of the turbomachine of FIG. 2 according to a fourth variant,

FIG. 8 is a simplified view along a radial axis of an arm for rotating a variable-setting blade of the turbomachine of FIG. 2, and

FIG. 9 is a perspective and sectional partial view of a satellite roller screw of the pitch change mechanism of FIG. 3.

### DETAILED DESCRIPTION OF ONE EXEMPLARY EMBODIMENT

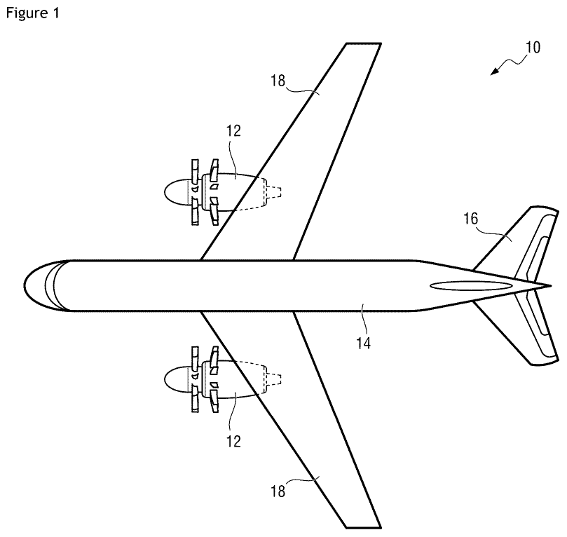

The aircraft 10 represented in FIG. 1 comprises turbomachines 12 to propel it.

In the example represented, the aircraft 10 is an airplane. It typically comprises a fuselage 14, a tailplane 16 and two wings 18. There are here two turbomachines 12, each housed under a respective wing 18. As a variant (not represented), the turbomachines 12 are disposed along the fuselage 14, for example in the vicinity of the empennage 16. Still as a variant (also not represented), the aircraft 10 comprises a single turbomachine 12 or at least three turbomachines 12.

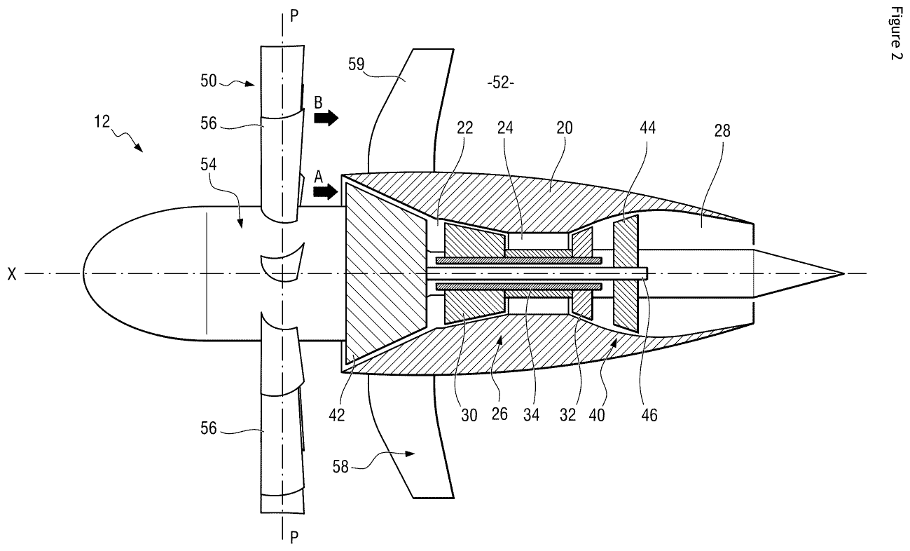

One of the turbomachines 12 is represented in FIG. 2.

As can be seen in this FIG. 2, the turbomachine 12 is elongated along a longitudinal axis X. It typically has angular symmetry about said longitudinal axis X, that is to say there is at least one angle for which the turbomachine is invariant by rotation about the longitudinal axis X.

Here and hereinafter, the terms “internal” and “external”, “inner” and “outer”, as well as their variations, are understood with reference to the axis X, an element described as “internal” or “inner” being oriented towards the axis X while an “external” or “outer” element is oriented opposite to the axis X.

The turbomachine 12 conventionally comprises a nacelle 20, an inner flowpath 22 for the circulation of an air stream through the nacelle 20, a combustion chamber 24 housed in the flowpath 22, a drive body 26 and a gas exhaust nozzle 28.

In the following, the terms “upstream” and “downstream” refer to a way of flow of an air stream through the flowpath 22.

The drive body 26 comprises a compressor 30, a turbine 32 and a transmission shaft 34 coupling the turbine 32 to the compressor 30 for the driving of the compressor 30 by the turbine 32. The compressor 30 is disposed upstream of the combustion chamber 24 and supplies the combustion chamber 24 with compressed air. The turbine 32 is disposed downstream of the combustion chamber 24 and receives the exhaust gases leaving the combustion chamber 24.

The transmission shaft 34 has the longitudinal axis X as axis of rotation.

The transmission shaft 34 is guided in rotation relative to the nacelle 20 by means of bearings (not represented).

In the example represented, the turbomachine 12 is a multi-spool turbomachine, particularly a double-spool turbomachine, comprising a low-pressure body 40 in addition to the drive body 26. The drive body 26 then constitutes a high-pressure body, the compressor 30 being a high-pressure compressor, the turbine 32 being a high-pressure turbine and the transmission shaft 34 being a high-pressure shaft.

The low-pressure body 40 comprises a low-pressure compressor 42, a low-pressure turbine 44 and a low-pressure shaft 46 coupling the low-pressure turbine 44 to the low-pressure compressor 42 for the driving of the low-pressure compressor 42 by the low-pressure turbine 44.

The low-pressure compressor 42 is disposed upstream of the high-pressure compressor 30 and supplies the latter with compressed air. The low-pressure turbine 44 is disposed downstream of the high-pressure turbine 32 and receives the exhaust gases leaving the latter.

The low-pressure shaft 46 is guided in rotation relative to the nacelle 20 by means of bearings (not represented).

The low-pressure shaft 46 is coaxial with the high-pressure shaft 34. It therefore also has the longitudinal axis X as axis of rotation. Particularly, the low-pressure shaft 46 extends inside the high-pressure shaft 34.

The turbomachine 12 also comprises a fan 50 for driving the air stream in an outer circulation flowpath 52 surrounding the nacelle 20. A primary air stream A (hot) constituted by the portion of the air stream driven in the inner circulation flowpath 22, and a secondary air stream B (cold) constituted by the portion of the air stream driven in the outer circulation flowpath 52 are thus distinguished.

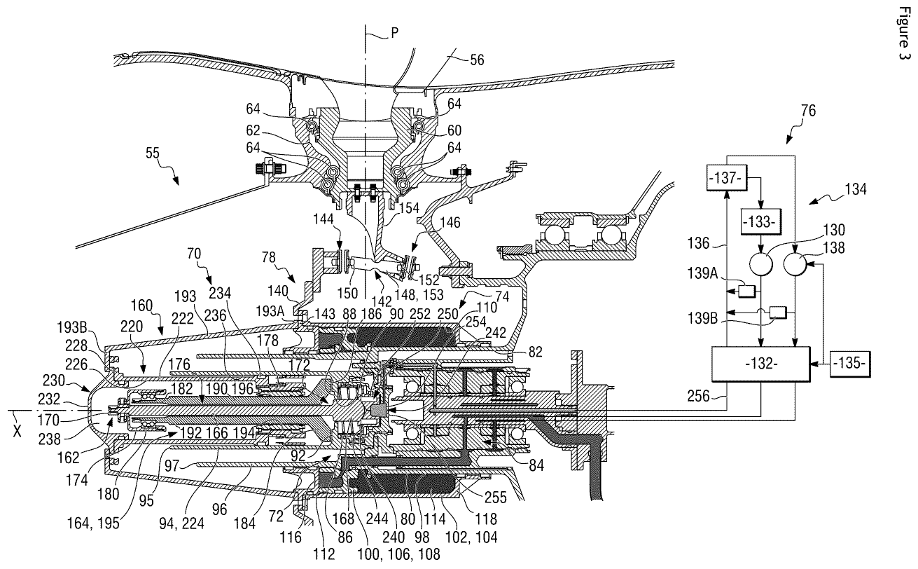

The fan 50 comprises a fan rotor 54. This fan rotor 54 is rotatably mounted relative to the nacelle 20 about the longitudinal axis X. It comprises a hub 55 (FIG. 3) provided with fan blades 56 extending substantially radially outward from the hub 55. These blades 56, when rotated, drive the air stream in the outer circulation flowpath 52.

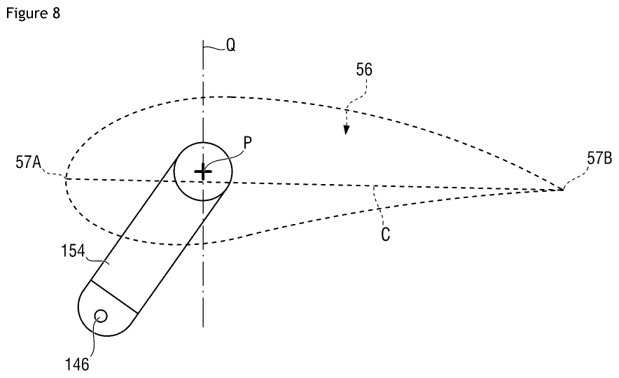

As visible in FIG. 8, each blade 56 comprises a leading edge 57A, a trailing edge 57B and a chord C connecting the leading edge 57A to the trailing edge 57B.

Returning to FIG. 2, the fan rotor 54 is driven in rotation by the low-pressure turbine 44, via the low-pressure shaft 46. In the example represented, this driving is direct, that is to say the fan rotor 54 is secured in rotation to the low-pressure shaft 46. As a variant (not represented), this driving is achieved via a reduction gear allowing the fan rotor 54 to rotate at a speed lower than that of the low-pressure shaft 46.

In the example represented, the fan 50 also comprises a fan stator 58 comprising vanes 59 arranged at the periphery of the nacelle 20, in the outer circulation flowpath 52, along a plane orthogonal to the longitudinal axis X. This fan stator 58 is here arranged downstream of the fan rotor 54. As a variant (not represented), the fan 50 comprises, instead of the fan stator 58, a counter-rotating fan rotor.

Advantageously, the fan 50 is, as represented, unducted, that is to say the outer circulation flowpath 52 has no peripheral delimitation. The turbomachine 12 is then constituted, as represented, by a turbojet engine with unducted fan or, as a variant, by a turboprop. As a variant (not represented), the outer circulation flowpath 52 is defined between the nacelle 20 and a fan casing surrounding the fan 50; the turbomachine 12 is then typically constituted by a high bypass ratio turbojet engine, the bypass ratio being defined as the ratio of the flow rate of the secondary stream B (cold) to the flow rate of the primary stream A (hot).

In the example represented, the turbomachine 12 is particularly of the “puller” type, that is to say the fan 50 is disposed upstream of the inner circulation flowpath 22 and also drives the air stream in the latter. As a variant (not represented), the turbomachine is of the “pusher” type, that is to say the fan 50 is placed around the downstream half of the nacelle 20.

The blades 56 of the fan rotor 54 are variable-setting blades, that is to say each blade 56 is pivotally mounted relative to the hub 55 about an own pivot axis P. This pivot axis P extends along the direction of elongation of the blade 56. It is orthogonal to the longitudinal axis X.

Each blade 56 is particularly able to pivot about the axis P relative to the hub 55 between a position called feather position in which the chord C of the blade 56 is substantially parallel to the longitudinal axis X, and a position called flat position in which the chord C of the blade 56 is substantially orthogonal to the longitudinal axis X. Preferably, each blade 56 is also able to pivot beyond the flat position to a position called reverse position in which the chord C of the blade 56 forms an angle strictly greater than 90°, for example substantially equal to 95°, with the longitudinal axis X. Since the blades 56 are most often twisted, the chord C taken as a reference for the measurement of the setting angle is, by convention, constituted by the chord of the blade at 75% of the radius of the fan rotor 54.

For this purpose, each blade 56 is secured, as seen in FIG. 3, to a fastener 60 disposed at the blade root. This fastener 60 is rotatably mounted relative to the hub 55 about the pivot axis P. More specifically, the fastener 60 is rotatably mounted inside a housing 62 arranged in the hub 55 by means of balls 64 or other rolling elements.

The fan 50 further comprises a pitch change mechanism 70 for adjusting the setting angle of each blade 56 about its pivot axis P so as to adapt the performance of the turbomachine 12 to the different flight phases.

With reference to FIG. 3, this pitch change mechanism 70 comprises a frame 72, a control actuator 74, a system 76 for steering the actuator 74 and a connection system 78.

The frame 72 is secured to the hub 55 and is typically constituted by part of the hub 55. It is thus fixed relative to the pivot axes P.

The frame 72 comprises a base 80. This base 80 is centered on the longitudinal axis X. Here, it is traversed by the pivot axes P.

In the example represented, the base 80 delimits a housing 82 open downstream. This housing 82 is particularly cylindrical, typically cylindrical of revolution, and centered on the X axis. An oil transfer bearing 84 is received in said housing 82.

The base 80 also delimits a cavity 86 opening out into an upstream face 88 of the base 80 through an orifice 90 which is here centered on the axis X. This cavity 86 is particularly cylindrical, typically cylindrical of revolution, and centered on the axis X. It is interposed between the upstream face 88 and the housing 82.

The base 80 has a stopper 92 oriented upstream. This stopper 92 is here formed by part of the upstream face 88. It extends substantially radially and is particularly arranged around the orifice 90.

In the example represented, the frame 72 also comprises a cylinder 94 protruding upstream from the base 80. This cylinder 94 is centered on the axis X and open at its upstream end 95. It extends around the stopper 92. It is typically cylindrical of revolution.

Here, the frame 72 also comprises a peripheral cylinder 96, coaxial with the cylinder 94 and surrounding the latter, protruding upstream from the base 80. This cylinder 96 is open at its upstream end 97. It is typically cylindrical of revolution.

The base 80 and the peripheral cylinder 96 together delimit an outer peripheral surface 88 of the frame 72. This outer peripheral surface 88 is substantially cylindrical and centered on the axis X. It is oriented radially outward.

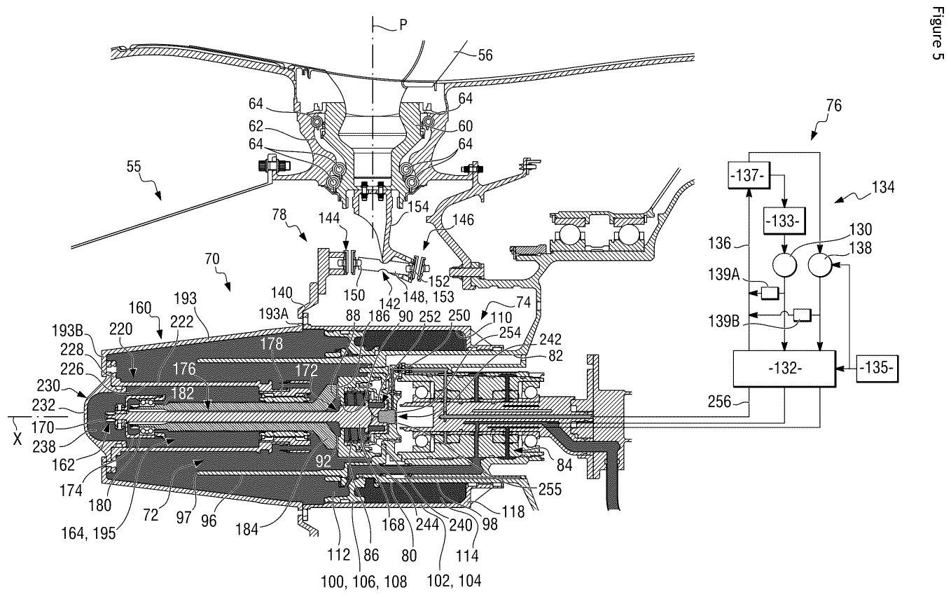

As a variant, as represented in FIG. 5, the frame 72 does not comprise the cylinder 94.

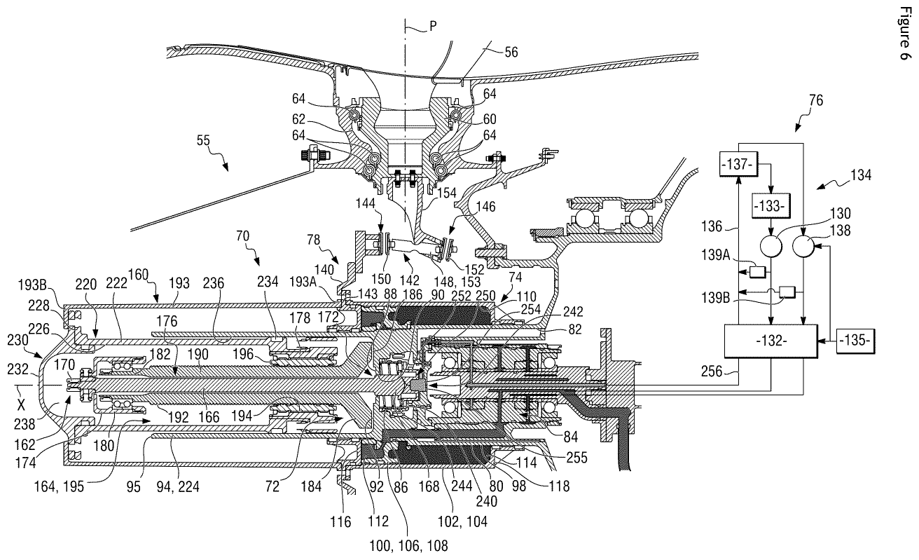

Further as a variant, as represented in FIG. 6, the frame 72 does not comprise the peripheral cylinder 96. The outer peripheral surface 88 is then delimited by the base 80 and the cylinder 94.

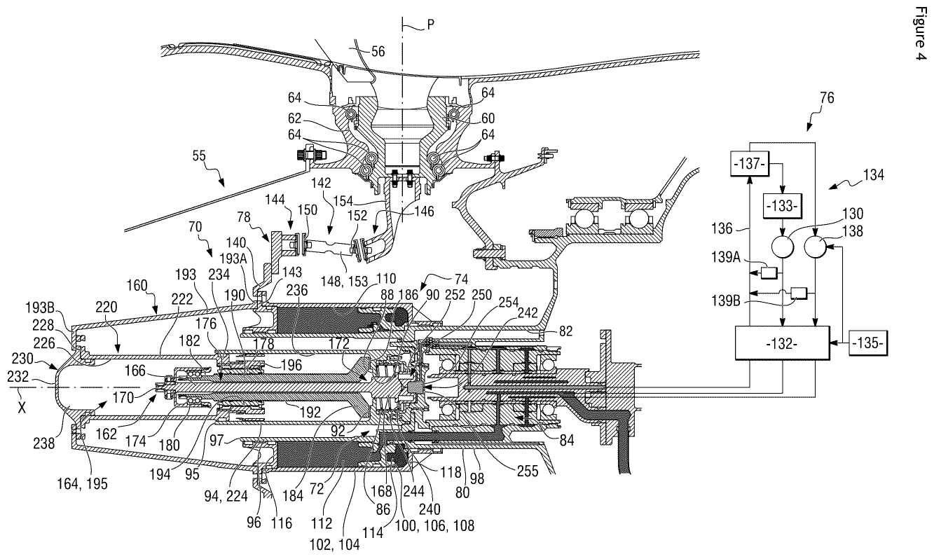

Returning to FIG. 3, the control actuator 74 includes a fixed part 100, secured to the frame 72, and a movable part 102 movable in translation along the longitudinal axis X relative to the fixed part 100 between a retracted position represented in FIG. 3, and a deployed position represented in FIG. 4. Optionally, the movable part 102 is also movable in rotation about the longitudinal axis X over a restricted angle, for example of the order of 5°.

The control actuator 74 comprises particularly a continuous cylinder 104 forming one of the fixed part 100 and of the movable part 102 and a piston 106 forming the other of the fixed part 100 and of the movable part 102. Here, the cylinder 104 forms the movable part 102 and the piston 106 forms the fixed part 100. As a variant (not represented), it is the opposite: the cylinder 104 forms the fixed part 100 and the piston 106 forms the movable part 102.

Thus, in the example represented, the cylinder 104 extends around the outer peripheral surface 88 of the frame 72, coaxially with the latter, and the piston 106 is constituted by a flange 108 secured to the frame 72 extending radially outward from the outer peripheral surface 88 to the cylinder 104.

The cylinder 104 delimits an inner cavity 110. The piston 106 divides said inner cavity 110 into two contiguous fluid chambers 112, 114. Each contains a control fluid, typically constituted by an oil, to control the displacement of the movable part 102 relative to the fixed part 100. This control fluid is at a first pressure in the first fluid chamber 112 and at a second pressure in the second fluid chamber 114. The first and second fluid chambers 112, 114 are arranged such that the relative increase in the first pressure (that is to say relative to the second pressure) causes the displacement of the piston 110 towards its deployed position, the relative increase in the second pressure (that is to say relative to the first pressure) causing the displacement of the piston 110 towards its retracted position.

Here, each of the fluid chambers 112, 114 is delimited internally by the outer peripheral surface 88 of the frame 72 and externally by the cylinder 104. The first fluid chamber 112 is also delimited at its downstream end by the piston 106 and the second fluid chamber 114 is delimited at its upstream end by the piston 106.

The control actuator 74 is thus particularly compact, which makes it possible to lighten it.

In the example represented in FIG. 3, the movable part 102 also comprises an upstream guide bushing 116 and a downstream guide bushing 118 each secured to the cylinder 104 and extending radially inward from the cylinder 104 to the outer peripheral face 88 of the frame 72. The upstream guide bushing 116 is disposed upstream of the piston 106 and delimits an upstream end of the first fluid chamber 112. The downstream guide bushing 118 is disposed downstream of the piston 106 and delimits a downstream end of the second fluid chamber 114.

In the example represented in FIG. 3, each of the upstream and downstream guide bushings 116, 118 constitutes a sealing bushing and longitudinally closes the first fluid chamber 112, respectively the second fluid chamber 114. The fluid chambers 112, 114 are thus closed at each of the longitudinal ends of the control actuator 74.

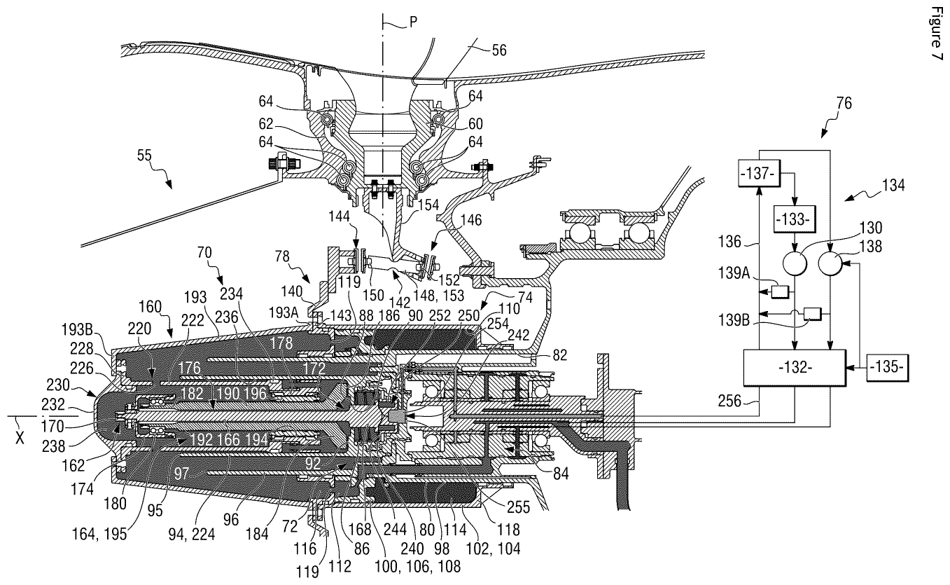

As a variant, as represented in FIG. 7, only the downstream guide bushing 118 constitutes a sealing bushing. The upstream guide bushing 118 has bores 119 allowing the control fluid to flow through the upstream guide bushing 118.

As a further variant, as represented in FIG. 5, the movable part 102 does not comprise an upstream guide bushing 118.

Returning to FIG. 3, the steering system 76 comprises a pressure generator 130 for bringing the control fluid to a third pressure higher than the first and second pressures, a pressure monitoring unit 132 for adjusting the pressure of the control fluid in the first and second fluid chambers 112, 114 by means of the third pressure, and a return line 136 for discharging the depressurized control fluid. The steering system 76 also comprises a main tank 133, a backup circuit 134 and a control module 135.

The pressure generator 130 comprises for example a pump able to pump the fluid to bring it to the third pressure, for example 100 bars. A main pressure relief valve 139A allows discharging part of the control fluid towards the return line 136 when the pressure of the control fluid downstream of the pressure generator 130 exceeds the third pressure.

The pressure monitoring unit 132 is supplied with control fluid at the third pressure by the pressure generator 130. It is fluidly connected to the first fluid chamber 112 and to the second fluid chamber 114 via the oil transfer bearing 106. It is able to distribute the control fluid between the first fluid chamber 112 and the second fluid chamber 114 so as to adjust the fluid pressure inside each of these chambers 112, 114 and thus adjust the position of the piston 110 between its retracted and deployed positions. It is also able to discharge control fluid coming from the first and second fluid chambers 112, 114 into the return line 136.

The main tank 133 is configured to collect depressurized control fluid coming from the return line 136. It supplies the pressure generator 130.

The backup circuit 134 is able to supply the first fluid chamber 112 with control fluid so as to move the piston 110 to its deployed position in case of failure of the pressure generator 130. For this purpose, the backup circuit 134 comprises an auxiliary tank 137 and an auxiliary pump 138. In the example represented, it also comprises an auxiliary pressure relief valve 139B.

The auxiliary tank 137 is configured to collect depressurized control fluid coming from the return line 136. It supplies the auxiliary pump 138. In the example represented, it also supplies the main tank 133, the depressurized control fluid coming from the return line 136 passing through the auxiliary tank 137 before reaching the main tank 133.

The auxiliary pump 138 is able to pump the control fluid into the auxiliary tank 137 to bring it to the third pressure. It is fluidly connected to the pressure monitoring unit 132 so as to supply it with control fluid at the third pressure, the pressure monitoring unit 132 being configured to redirect the entire control fluid coming from the auxiliary pump 138 to the first fluid chamber 112.

The pressure relief valve 139B is able to discharge part of the control fluid to the return line 136 when the pressure of the control fluid downstream of the auxiliary pump 138 exceeds the third pressure.

The control module 135 is configured to receive a setting instruction (not represented) and deduce therefrom a control signal transmitted to the pressure monitoring unit 132. Particularly, the control module 135 is configured to transmit to the pressure monitoring unit 132 a control signal intended to increase the fluid pressure in the first chamber 112 when the setting instruction aims to increase the pitch of the blades 56, and to transmit to the pressure monitoring unit 132 a control signal intended to increase the fluid pressure in the second chamber 114 when the setting instruction aims to reduce the pitch of the blades 56.

The control module 135 is also configured to transmit to the backup circuit 134, more particularly to its auxiliary pump 138, a start instruction in case of failure of the pressure generator 130.

The connection system 78 connects the movable part 102 to each blade 56 so as to convert the translation of the movable part 102 along the longitudinal axis X and, where appropriate, the rotation of the movable part 102 about the longitudinal axis X into a rotation of each blade 56 about its pivot axis P. Particularly, the connection system 78 connects the movable part 102 to each blade 56 so as to convert:
the translation of the movable part 102 along the longitudinal axis X in a first way into a rotation of the variable-setting blade 56 about the pivot axis P towards the flat position, and
the translation of the movable part 102 along the longitudinal axis X in a second way opposite to the first way into a rotation of the variable-setting blade 56 about the pivot axis P towards the feather position.

For this purpose, the connection system 78 comprises a synchronizing ring 140 secured to the movable part 102 and, for each of the blades 56, a mechanism 142 for connecting the blade 56 to the synchronizing ring 140.

The synchronizing ring 140 extends in a radial plane around the movable part 102. It is particularly fixed to an upstream end 143 of the movable part 102.

Each connection mechanism 142 comprises a first articulation 144 secured to the movable part 102, a second articulation 146 secured to the blade 56, away from the pivot axis P of said blade 56, and a connection member 148 connecting the first articulation 144 to the second articulation 146.

The first articulation 144 is carried by the synchronizing ring 140. Here, it is constituted by a connection ball joint.

The second articulation 146 is also constituted by a ball joint connection. It is eccentric relative to the pivot axis P.

The connection member 148 has a first end 150 articulated to the first articulation 144 and a second end 152 articulated to the second articulation 146. Advantageously, the connection member 148 is rigid and of adjustable length, that is to say the distance between the first and second ends 150, 152 can be modified, which makes it possible to accurately adjust the length when stationary so as to allow the steering of the setting angle of each blade 56 by the pitch change mechanism 70.

The connection member 148 is here constituted by a connecting rod 153.

In the example represented, each connection mechanism 142 also comprises a crank 154 connecting the fastener 60 to the second articulation 146. This crank 154 is rigid and secured to the fastener 60. It extends at least partly along a direction orthogonal to the pivot axis P. It forms an arm for rotating the blade 56.

In the example represented, the first way goes from upstream to downstream, that is to say the displacement of the movable member 102 towards the stopper 92 (in other words towards its retracted position) causes a rotation of each blade 56 towards its flat position, and the second way goes from downstream to upstream, that is to say the displacement of the movable member 102 away from the stopper 92 (in other words towards its deployed position) causes a rotation of each blade 56 towards its feather position. In addition, the first articulation 144 is disposed upstream of the second articulation 146.

For this purpose, the second articulation 146 is, as visible in FIG. 8, placed opposite to the trailing edge 57B relative to a plane Q orthogonal to the chord C and containing the pivot axis P.

As a variant (not represented), the first way goes from downstream to upstream, the first articulation 144 being disposed downstream of the second articulation 146. The second articulation 146 is then placed on the same side of the trailing edge 57B relative to the plane Q orthogonal to the chord C and containing the pivot axis P.

These particular arrangements allow, when the pitch change mechanism 70 is immobilized, that the natural biases of the blade 56 towards its flat position make the connection member 148 work in traction and not in compression. The risk of buckling of the connection member 148 is therefore very low, so that it is possible to use a relatively little resistant connection member 148 and thus to lighten the pitch change mechanism 70.

The pitch change mechanism 70 also comprises a pitch locking device 160 suitable for blocking the translation of the movable part 102 of the control actuator 74 in the first way, that is to say here towards its retracted position.

This locking device 160 comprises a support member 162 and a screw-nut system 164.

The support member 162 is movable in translation relative to the frame 72 along the longitudinal axis X between an operating position (represented in FIGS. 3 to 7) and a locking position (not represented). The support member 162 moves from its operating position to its locking position by translation in the first way, that is to say in the example represented, by translation from upstream to downstream. In other words, the operating position of the support member 162 is disposed upstream of its locking position.

The support member 162 comprises a body 166 elongated along the longitudinal axis X and centered on the longitudinal axis X. Said body 166 has a first longitudinal end 168, particularly a downstream longitudinal end, engaged through the orifice 90 of the frame 72, and a second free longitudinal end 170. The body 166 is here solid.

The first longitudinal end 168 and the orifice 90 of the frame 72 together form a guide system 172 guiding the support member 162 relative to the frame 72. This guide system 172 is here disposed on a downstream side of the screw-nut system 164.

The support member 162 also comprises a sleeve 174 secured to the body 166 and arranged around the second longitudinal end 170 of the body 166.

The screw-nut system 164 comprises a screw 176 and a nut 178.

The screw 176 extends around the body 166 of the support member 162 and is coaxial with said body 166. It is secured in translation to the support member 162 and movably mounted in rotation about the longitudinal axis X relative to the support member 162. For this purpose, the screw 176 is assembled to the support member 162 by means of a bearing 180. This bearing 180 is here interposed between the sleeve 174 of the support member 162 and an end portion 182 of the screw 176, housed between the body 166 and the sleeve 174.

The screw 176 has a second longitudinal end portion 184 opposite to the end portion 182. This second longitudinal end portion 184 defines a radial abutment surface 186. This abutment surface 186 is at a distance from the frame 72 when the support member 162 is in the operating position and bears against the stopper 92 of the frame 72 when the support member 162 is in the locking position.

Here, the second longitudinal end portion 184 flares from a threaded body 190 of the screw 176 to the abutment surface 186. Thus, the contact surface between the abutment surface 186 and the stopper 92 is increased, which increases the friction forces between the abutment surface 186 and the stopper 92 and allows for better transmission of the braking and blocking forces.

The abutment surface 186 and the stopper 92 are each smooth here. As a variant (not represented), the abutment surface 186 and/or the stopper 92 have roughnesses, so as to further increase the friction forces between the abutment surface 186 and the stopper 92 and allow for even greater transmission of the forces.

The abutment surface 186 extends particularly substantially radially. It is oriented in the first way, that is to say in the example represented, downstream. Here, it is arranged at a downstream end of the screw 176.

The threaded body 190 extends from one of the end portions 182, 184 to the other. It has an outer thread 192 on its circumference.

The threaded body 190 and the nut 178 are housed inside the cylinder 94 of the frame 72.

The nut 178 is secured to the movable part 102 of the actuator 74 and coaxial with the screw 176. It cooperates with the screw 176 so that a translation of the nut 178 along the longitudinal axis X relative to the screw 176 causes the rotation of the screw 176 about the longitudinal axis X relative to the support member 162.

The nut 178 has an inner tapping 194.

The screw-nut system 164 is particularly formed by a reversible satellite roller screw system 195. Conventionally, this satellite roller screw system 195 comprises, in addition to the screw 176 and the nut 178, a plurality of rollers 196 interposed between the screw 176 and the nut 178, each roller 196 being elongated parallel to the longitudinal axis X.

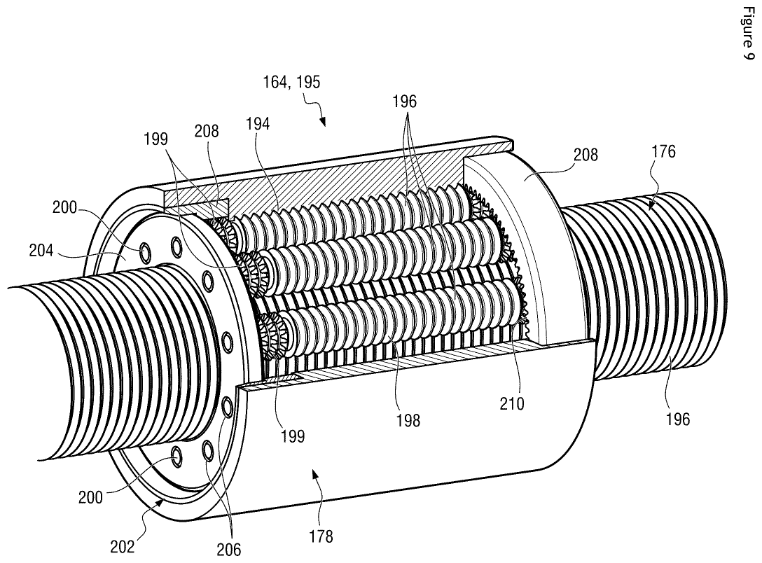

As seen in FIG. 9, each roller 196 has a thread 198 engaged with the outer thread 192 of the screw 176 and the inner tapping 194 of the nut 176. It further comprises outer gear teeth 199 located at its ends and extended by smooth journals 200.

The satellite roller screw system 195 also has, still conventionally, a device 202 for guiding and holding the rollers 196. This guide and holding device 202 comprises roller holders 204 (also called spacer bushings) which are mounted coaxially with the screw 176, between the latter and the nut 178, with notches 206 accommodating the journals 200 of the rollers 196. It also comprises a synchronization gear teeth 210 in which the outer gear teeth 198 located at the respective ends of the rollers 196 mesh. This meshing of the outer gear teeth 198 in the synchronization gear teeth 210 forms a planetary gear train whose role is to ensure synchronization of the satellite movement, also called planetary or epicyclic movement, of the rollers 196, thus smoothing the movement of the rollers 196 by helping them to roll easily, with the least possible slippage, on the thread 192 of the screw 176 and the tapping 194 of the nut 178.

In the example represented, the satellite roller screw system 195 is of the standard type, the rollers 196 being secured in translation to the nut 178. The synchronization gear teeth 210 are constituted by the inner gear teeth of rings 208 secured to the nut 178 and mounted respectively at each longitudinal end of the nut 178, the latter having a longitudinal extension substantially equal to that of the threaded portion of the rollers 196 and lower than that of the threaded body 190 of the screw 176.

As a variant (not represented), the satellite roller screw system 195 is of the inverted type, the rollers 196 being secured in translation to the screw 176. The synchronization gear teeth 210 are then constituted by two outer gear teeth of the screw 176 at each longitudinal end of the threaded body 190, the latter having a longitudinal extension substantially equal to that of the threaded portion of the rollers 196 and lower than that of the nut 178.

As a further variant, the satellite roller screw system 195 is constituted by a recirculating satellite roller screw system such as, for example, the one described in document EP 275 504 A2, or by a roller bearing screw system such as for example the one described in document EP 168 942 A1 or the one described in document EP 671 070 A1.

This characteristic allows for good transmission of the forces from the nut 178 to the screw 176 by the screw-nut system 164, while maintaining a small pitch in the helical connection of the screw-nut system 164. Particularly, in case of blockage of the rotation of the screw 176, it allows immobilizing the nut 178 relative to the screw 176 even in the absence of a distinct locking nut. It is thus possible to eliminate the need for a distinct locking nut, which simplifies the manufacture and reduces the costs of the mechanism, while increasing its reliability and minimizing its mass.

As a variant (not represented), the screw-nut system 164 is constituted by a screw-nut system similar to the one described in EP 1 832 509.

Returning to FIG. 3, the pitch locking device 160 is here out of the fluid chambers 112, 114 of the control actuator 74. This arrangement makes it possible to assemble to the frame 72 the pitch locking device 160 and the actuator 74 separately from each other, which facilitates the mounting of the pitch change mechanism 70 and thus reduces costs.

As seen in FIG. 3, part of the pitch locking device 160 even extends longitudinally away from the actuator 74. In other words, there is a radial plane beyond which part of the pitch locking device 160 extends without the actuator 74 extending beyond said radial plane. Particularly, said part of the pitch locking device 160 extends upstream of the actuator 74.

To enable this arrangement, the pitch locking device 160 comprises a shroud 193 connecting the nut 178 to the movable part 102 of the actuator 74. This shroud 193 here protrudes longitudinally upstream from the control actuator 74. It is particularly frustoconical, its diameter decreasing from its downstream end 193A attached to the actuator 74, to its upstream end 193B attached to the nut 178.

The pitch locking device 160 is also longitudinally cantilevered relative to the frame 72. In other words, the entire part of the frame 72 supporting the locking device 160 is located longitudinally on the same side, here downstream, of the locking device 160; the locking device 160 is not framed longitudinally by the part of the frame 72 supporting it and no piece secured to the frame 72 supports the end of the pitch locking device 160 opposite to the one supported by the frame 72. Thanks to this arrangement, it is possible to do without a support disposed upstream of the locking device 160, which facilitates access to the pitch change mechanism 70 and more particularly to the connection system 78.

Thus, the control actuator 74 is disposed longitudinally on the same side of the nut 178, here the downstream side, as the guide device 172 and the stopper 92.

To ensure good support of the locking device 160 despite this cantilever, the pitch change mechanism 70 comprises a device 220 for guiding the nut 178 relative to the frame 72. This guide device 220 includes an inner cylinder 222 secured to the nut 178 and an outer cylinder 224 secured to the frame 72, the inner cylinder 222 cooperating with the outer cylinder 224 so as to slide longitudinally inside the latter.

The nut 178 is particularly mounted on an inner face 226 of the inner cylinder 222. The inner cylinder 222 has an upstream end 228 to which the upstream end 193B of the shroud 193 is fixed.

The outer cylinder 224 is here constituted by the cylinder 94 of the frame 72.

The pitch locking device 160 requires lubrication. For this purpose, the locking device 160 comprises a casing 230 at least partially delimiting an enclosure for the circulation of a lubricating fluid for the pitch locking device 160. This casing 230 is secured to the nut 178 and surrounds the nut 178, the screw 176 and the support member 162.

In the examples of FIGS. 3, 4 and 6, the casing 230 comprises the inner cylinder 222 and a plug 232 closing one end of the inner cylinder 222 opposite to the frame 72, here the upstream end 228. The inner cylinder 222 has at its periphery a sealing 234 in contact with an inner face 236 of the outer cylinder 224. Thus, the outer cylinder 224 and the casing 230 together delimit an enclosure 238 for the circulation of a lubricating fluid for the locking device 160. This enclosure 238 is fluidly isolated from the fluid chambers 112, 114 of the actuator 74 by the sealing 234 and the upstream guide bushing 116. The sealing 234 and the guide bushing 116 thus form sealing of the pitch change mechanism 70, fluidly isolating the fluid chambers 112, 114 of the actuator 74 from the pitch locking device 160.

Advantageously, the lubricating fluid for the locking device 160 is constituted by oil. The pitch locking device 160 then comprises an accumulator (not represented) allowing the storage of the lubricating fluid when the actuator 74 is in the retracted position and the transfer of the lubricating fluid into the enclosure 238 when the actuator 74 moves towards its deployed position. As a variant, the lubricating fluid for the locking device 160 is constituted by grease deposited on the screw 176 and the rolling of the bearing 180.

In the example of FIG. 5, where the outer cylinder 224 and the upstream guide bushing 116 are absent, as well as in FIG. 7, where the inner cylinder 222 and the upstream guide bushing 116 are pierced, the casing 230 is constituted by the shroud 193 and by a plug 239 closing the upstream end 193B of the shroud 193. The first fluid chamber 112 is then in fluid communication with the interior of the casing 230, the control fluid constituting the lubricating fluid for the locking device 160.

This variant eliminates the need for an accumulator. However, it requires a pump 130 with a higher flow rate than in the variant of FIGS. 3, 4 and 6.

The locking device 160 also comprises a return device 240 biasing the support member 162 towards its locking position and a holding device 242 for holding the support member 162 in its operating position when the pitch change mechanism 70 is in normal operating conditions.

The return device 240 is here constituted by a compression spring compressed between the frame 72 and a shoulder 244 secured to the support member 162. It is particularly housed in the cavity 86, between the shoulder 244 and the orifice 90.

The holding device 242 comprises a counterbalancing actuator 250 including a counterbalancing piston 252 and a counterbalancing chamber 254.

The counterbalancing piston 252 is movably mounted in translation along the longitudinal axis X relative to the frame 72. It is particularly coaxial with the support member 162. In the example represented, it is arranged in the longitudinal extension of the support member 162, between the support member 162 and the counterbalancing chamber 254.

The counterbalancing chamber 254 is delimited between the counterbalancing piston 252 and the frame 72. Particularly, the counterbalancing chamber 254 is delimited between the counterbalancing piston 252 and a bottom 255 of the cavity 86 opposite to the orifice 90; the guide system 172, the return device 240 and the holding device 250 are thus all disposed longitudinally on the same side, here the downstream side, of the screw-nut system 164 and therefore particularly of the nut 178.

The counterbalancing chamber 254 is fluidly connected to the pressure generator 130 by a fluid connection circuit 256 so as to be supplied with control fluid at the third pressure. It is intended to counterbalance the bias of the return device 240 when this supply is active.

For this purpose, the counterbalancing actuator 250 is arranged so that the pressure exerted on the piston 252 by the fluid contained in the chamber 254 is oriented in a direction opposite to that of the bias of the return device 250: in the example represented, the counterbalancing piston 252 is interposed between the chamber 254 and the shoulder 244, and the shoulder 244 is interposed between the piston 252 and the return device 240. In addition, the counterbalancing piston 252 and the counterbalancing chamber 254 are dimensioned so that, when the chamber 254 is supplied with control fluid at the third pressure, the force exerted by the control fluid on the piston 252 is greater than the bias of the return device 240.

Thus, when the supply of the chamber 254 with control fluid at the third pressure is active, the bias of the return device 240 is canceled and the support member 162 is held in the operating position.

In the example represented, the pressure monitoring unit 132 is fluidly interposed between the pressure generator 130 and the fluid connection circuit 256. It has a first configuration in which it isolates the fluid connection circuit 256 from the return line 136, and a second configuration in which it fluidly connects the fluid connection circuit 256 to the return line 136.

The pressure monitoring unit 132 is configured to be normally in its first configuration and to switch to its second configuration upon receipt of a control instruction transmitted by the control module 135.

A method for changing the pitch of the blades 56, implemented by the pitch change mechanism 70, will now be described.

During a first step of this method, the control module 135 first receives a setting instruction aiming to increase the pitch of the blades 56. The control module 135 then transmits to the pressure monitoring unit 132 a control signal intended to increase the fluid pressure in the first chamber 112. As the fluid pressure in the first chamber 112 increases, the movable part 102 of the actuator 74 moves in the second way, towards its deployed position which, via the connection system 78, causes the pivoting of the blades 56 towards the large pitches (that is to say towards the feather position).

Once the movable part 102 has reached an equilibrium position, it stabilizes, the blades 56 maintaining a fixed orientation.

During a second step of the pitch change method, the control module 135 first receives a setting instruction aiming to reduce the pitch of the blades 56. The control module 135 then transmits to the pressure monitoring unit 132 a control signal intended to increase the fluid pressure in the second chamber 114. As the fluid pressure in the second chamber 114 increases, the movable part 102 of the actuator 74 moves in the first direction towards its retracted position which, via the connection system 78, causes the pivoting of the blades 56 towards the small pitches (that is to say towards the flat position).

Once the movable part 102 has reached an equilibrium position, it stabilizes, the blades 56 maintaining a fixed orientation.

Optionally, the pitch change method also comprises, following the first or the second step, a step of locking in a controlled manner the orientation of the blades 56.

During this step, the control module 135 transmits a pitch locking command to the pressure monitoring unit 132. Under the effect of this command, the pressure monitoring unit 132 fluidly connects the fluid connection circuit 256 to the return line 136, causing a drop of the fluid pressure in the counterbalancing chamber 254. The fluid pressure in said chamber 254 is then insufficient to counterbalance the bias of the return device 240, which thus causes the displacement of the support member 162 towards its locking position.

During this displacement, the screw 176, while translating, rotates about the longitudinal axis X under the effect of the resistance imposed by the assembly of the nut 178 and of the rollers 194 (which are kept immobile in translation by the control actuator 74) until its abutment surface 186 bears against the stopper 92 of the frame 72, blocking the rotation of the screw 176 about the longitudinal axis X and its translation along the same axis X.

The blades 56 are thus blocked in their orientation even in case of loss of fluid pressure in the first chamber 112.

In case of loss of pressure in the second chamber 114 only, the movable part 102 of the actuator 74 is moved in the second way under the effect of the pressure difference between the two chambers 112, 114, driving with it the screw 176 and the support member 162, which returns to its operating position. The movable part 102 is therefore no longer immobilized and can continue to move in the second way until the blades 56 are in the feather position.

In case of malfunction of the steering system 76, typically in case of failure of the pressure generator 130, the pitch change method comprises an additional step of locking in a non-controlled manner the orientation of the blades 56.

During this step, the malfunction of the steering system 76 causes a drop of the fluid pressure in the counterbalancing chamber 254, typically because the pressure generator 130 is no longer able to bring the control fluid to the third pressure. The fluid pressure in said chamber 254 is then insufficient to counterbalance the bias of the return device 240, which thus causes the displacement of the support member 162 towards its locking position.

During this displacement, the screw 176 drives with it the nut 178 and the rollers 194, which are no longer held immobile in translation due to the loss of power to the control actuator 74. The blades 56 therefore pivot slightly towards the small pitches, until the abutment surface 186 of the screw 176 bears against the stopper 92 of the frame 72, blocking the rotation of the screw 176 about the longitudinal axis X and its translation along the same axis X.

The pivoting of the blades 56 towards the small pitches is then prevented by the locking device 160.

The non-controlled locking step is followed by a step of securing the fan 50. During this step, the backup circuit 134 is activated and supplies the first fluid chamber 112 with control fluid so as to increase the fluid pressure in this chamber. Under the effect of this pressure increase, the movable part 102 moves in the second way, driving with it the screw 176 and the support member 162, which returns to its operating position. The movable part 102 is therefore no longer immobilized and can continue to move downstream until the blades 56 are in the feather position.

It will be noted that these different steps can be implemented independently of one another.

Thus, thanks to the exemplary embodiments described above, it is possible to do without a support disposed upstream of the locking device 160, which facilitates access to the pitch change mechanism 70, and more particularly to the connection system 78, once it is assembled.

In addition, the mounting of the pitch change mechanism 70 is made easier, and its cost reduced.

Moreover, it is possible to lighten the pitch change mechanism 70 thanks to the compactness of the control actuator 74 and to the use of less resistant and therefore lighter connection members 148.

The exemplary embodiments described above also make it possible to eliminate the need for a locking nut distinct from the nut 178 of the screw-nut system 164. This results in a locking device 160 and, consequently, a pitch change mechanism 70 whose manufacture is simplified, whose costs are reduced and whose reliability is increased.

These exemplary embodiments finally allow for great accuracy in steering the setting angle of the blades 56, which authorizes on the hub 55 the close implantation of large blades 56 with complex geometry, thus increasing the efficiency of the turbomachine 12.

1. A pitch change mechanism for adjusting an angular position of at least one variable-setting blade about a pivot axis of the variable-setting blade, said pitch change mechanism comprising:
a frame fixed relative to the pivot axis,
a control actuator including a fixed part secured to the frame and a movable part movable in translation along a longitudinal axis relative to the fixed part between a retracted position and a deployed position, the movable part extending around the fixed part,
a connection system connecting the movable part- to the variable-setting blade so as to convert the translation of the movable part along the longitudinal axis into a rotation of the variable-setting blade about the pivot axis, and
a pitch locking device suitable for blocking the translation of the movable part relative to the fixed part in at least one way,
wherein the pitch locking device is longitudinally cantilevered relative to the frame.

2. The pitch change mechanism according to claim 1, wherein the pitch locking device comprises:
a support member, movable in translation relative to the frame along the longitudinal axis between an operating position and a locking position,
a guide system guiding the support member relative to the frame,
a return device biasing the support member towards its locking position,
a holding device for holding the support member in its operating position under normal operating conditions, and
a screw-nut system with:
a screw secured in translation to the support member and movably mounted in rotation about the longitudinal axis relative to the support member, the screw having an abutment surface which is at a distance from the frame when the support member is in the operating position and bearing against the frame when the support member is in the locking position, and
a nut secured to the movable part of the control actuator and coaxial with the screw, the nut cooperating with the screw so that a translation of the nut along the longitudinal axis causes a rotation of the screw about the longitudinal axis.

3. The pitch change mechanism according to claim 2, wherein the control actuator and the guide system are disposed longitudinally on a same side of the nut.

4. The pitch change mechanism according to claim 2, comprising a guide device for guiding the nut relative to the frame, said guide device including an inner cylinder secured to the nut and an outer cylinder secured to the frame, the inner cylinder cooperating with the outer cylinder so as to slide longitudinally inside the latter.

5. The pitch change mechanism according to claim 2, wherein the pitch locking device comprises a casing secured to the nut and surrounding the nut, the screw and the support member.

6. The pitch change mechanism according to claim 1, wherein the control actuator comprises a cylinder forming the movable part and a piston forming the fixed part.

7. The pitch change mechanism according to claim 6, wherein the cylinder delimits an inner cavity and the piston divides said inner cavity into two fluid chambers each containing a control fluid to control the displacement of the movable part relative to the fixed part.

8. The pitch change mechanism according to claim 5, wherein the control actuator comprises a cylinder forming the movable part and a piston forming the fixed part, the cylinder delimiting an inner cavity and the piston dividing said inner cavity into two fluid chambers each containing a control fluid to control the displacement of the movable part relative to the fixed part, and wherein one of the two fluid chambers is in fluid communication with the interior of the casing, the control fluid constituting a lubricating fluid for the locking device.

9. A fan rotor for a turbomachine comprising a hub and a plurality of variable-setting blades each pivotable relative to the hub about an own pivot axis, the fan rotor further comprising a pitch change mechanism according to claim 1 to adjust an angular position of each of the variable-setting blades about its respective pivot axis.

10. A turbomachine comprising a fan rotor according to claim 9.

11. An aircraft comprising at least one turbomachine according to claim 10.

12. A method for changing the pitch of the blades of a fan rotor for a turbomachine, each pivotable relative to a hub of the fan rotor about an own pivot axis, said method comprising adjusting an angular position of each of said blades about its respective pivot axis by means of a pitch change mechanism according to claim 1.

13. The pitch change mechanism according to claim 3, wherein the control actuator and the guide system are disposed longitudinally on a downstream side of the nut.
